(19) United States
(12) Patent Application Publication
(10) Pub. No.: US 2008/0116390 A1
(43) Pub. Date: May 22, 2008

(54) Delivery of a Charged Particle Beam

(75) Inventors: John Stuart Gordon, Henfield (GB); Raymond Paul Boisseau, Waltham, MA (US); William Philip Nett, Waltham, MA (US)

Correspondence Address: FISH & RICHARDSON P.C., P.O. BOX 1022, MINNEAPOLIS, MN, 55440-1022, US

(73) Assignee: PYRAMID TECHNICAL CONSULTANTS, INC., Lexington, MA (US)

(21) Appl. No.: 11/876,496

(22) Filed: Oct. 22, 2007

Related U.S. Application Data
(60) Provisional application No. 60/866,227, filed on Nov. 17, 2006.

(51) Int. Cl. H01J 1/50

(52) U.S. Cl. 250/396 ML

(57) ABSTRACT

Delivering a beam of charged particles includes providing the beam along a first trajectory to a linear array of magnets and energizing two or more of the magnets in the linear array to deflect the beam to a second trajectory, in which the second trajectory is substantially orthogonal to the first trajectory. The beam can be deflected to any position along a straight linear path.

### CROSS-REFERENCE TO RELATED APPLICATION(S)

This application claims the priority of U.S. Provisional Patent Application No. 60/866,227, filed on Nov. 17, 2006. The disclosure of that application is incorporated herein by reference.

### BACKGROUND

The present disclosure is directed towards delivery of a charged particle beam.

A charged particle beam refers to any spatially localized and directed beam that includes particles with an electric charge such as an electrons or ions. Charged particle beams can be used in a wide variety of applications including, for example, medical therapy and diagnostics, ion implantation, sterilization, synchrotron radiation experiments and industrial radiography. In some cases, the charged particle beam in those applications has a relatively small cross-section and is delivered to various locations on a target that has a much larger cross-sectional area. In this way, it is possible to deliver the beam to discrete positions on the target or to simulate the effect of a beam having a large cross-sectional area by quickly scanning the particle beam across the target. To bring about a particular desired effect on the target, the dwell time of the incident beam can be modified.

In some applications, an object that has yet to be examined or dosed is translated on a conveyor or, equivalently, the beam generation apparatus is translated relative to the object. The particle beam is directed towards the object along a line substantially orthogonal to the relative movement of the object and can be scanned at a much higher rate than the relatively slow mechanical translation, in order to cover the entire target with the beam. The particle beam may strike the object directly, or, if the particles are electrons, they may strike a target to create X-ray beams which then are directed to the object with collimation as necessary. In radiographic imaging applications, the beam position along the line can define one coordinate of a volume element that is being examined at any instant, with the other coordinates set by the detector system and the mechanical translation device.

In another application, a charged particle beam is delivered to work-pieces such as semiconductor wafers for doping, or to work-pieces such as metal, polymer items or bulk material for changing their material properties or sterilizing them. In those cases, it is beneficial if the beam can be exposed uniformly on the material. Accordingly, it is preferable if the beam delivery motion profile can be appropriately controlled. In many such applications it also is important that the angle of incidence of the beam on the work piece be controlled.

An example of a way to deliver a charged particle beam is shown in FIG. 1. In the example, a small charged particle beam 1 is directed towards a scanning electromagnet 3. The scanning electromagnet 3 is used to steer and deflect the beam within a certain fixed range. The beam or beams which emerge from the scanning electromagnet are directed towards a subsequent parallelizing corrector (or collimator) magnet 5. The corrector magnet 5 causes the various beam rays to be deflected such that they emerge parallel to one another in the direction of a target 7. This method is sometimes used in semiconductor ion implantation and in electron or X-ray treatment of objects for modifying material properties or sterilization. However, if the linear extent of the scan is long, this technique requires the size of the corrector magnet 5 and vacuum vessels (which are used to transport the particle beam) to be very large. Furthermore, the entire system for scanning the beam, including the beam path entering and exiting the system, lies in one plane. If the final paths are required to be directed vertically downwards, for example, then the overall height of the system may be excessive. In addition, the beam 1 is sensitive to minor mis-steering as well as the earth's magnetic field which can lead to undesirable changes in the beam output trajectory.

U.S. Pat. No. 4,295,048 describes a linear array of discrete dipole magnets 11, in which energizing a single magnet in the array is capable of bending a particle beam 1 by 90° to impinge upon a target 7 (see FIG. 2). This allows a beam to follow a discrete trajectory 15 and impinge at a discrete position on the target 7 depending on which magnet is energized. However, there is only a single position for each energized magnet 11, at the output of the array, where the beam will emerge at 90° with respect to its entrance trajectory. Therefore, the number of exit beam positions that are perpendicular to the entrance trajectory is limited by the number of magnets. Furthermore, the shape and size of the magnets 11 as well as the size of the spacing between the magnets 11 limits how close the exit beam positions can be to each other.

### SUMMARY

The details of one or more embodiments of the invention are set forth in the description below, the accompanying drawings and the claims.

For example, in one aspect a method for delivering a beam of charged particles includes providing the beam along a first trajectory to a linear array of magnets and energizing two or more of the magnets in the linear array to deflect the beam to a second trajectory, in which the second trajectory is substantially orthogonal to the first trajectory.

Some implementations include one or more of the following features. For example, the beam is deflectable to any position along a straight linear path.

In some cases, the first trajectory is substantially parallel to the straight linear path.

In some examples, two or more magnets in the linear array can be subsequently energized to deflect the beam to a third trajectory, in which the third trajectory is substantially parallel to the second trajectory.

In some cases, charged particles from the second and third trajectory are aligned at any position along a straight linear path.

In some implementations, the first trajectory is substantially parallel to the straight linear path.

In some examples, the beam is deflected onto a target.

In certain cases, energizing the two or more magnets includes retrieving energy from an energy storage device.

In some implementations, the two or more magnets can be de-energized. De-energizing the two or magnets can include delivering energy to an energy storage device.

In some cases, the linear array of magnets includes one or more spacings, in which each spacing is between a set of adjacent magnets and extends in a direction parallel to the first trajectory and in which the second trajectory coincides with one of the spacings.

In another aspect, a method of delivering a charged particle beam includes providing the beam along a first trajectory to a linear array of deflecting elements and deflecting the beam along a plurality of exit trajectories to any position on a linear path, in which each exit trajectory is substantially parallel to one another.

For example, in some cases, each exit trajectory is substantially orthogonal to the linear path.

In some implementations, each exit trajectory is substantially orthogonal to the first trajectory.

In certain instances, the first trajectory is substantially parallel to the linear path.

In some implementations, deflecting the beam along a plurality of exit trajectories includes successively activating a plurality of the deflecting elements in the linear array. Activating the plurality of deflecting elements can include retrieving energy from an energy storage device.

In some examples, a plurality of deflecting elements can be de-activated. De-activating the plurality of deflecting elements can include delivering energy to an energy storage device.

In some cases, the linear path is arranged at an oblique angle with respect to a direction of motion of a target.

The deflecting elements can be sequentially activated such that charged particles within the exit trajectories impinge on the target along a line substantially orthogonal to the target direction of motion.

In another aspect, an apparatus for delivering a beam of charged particles includes a deflecting instrument operable to deflect the beam along a plurality of exit trajectories to any position on a linear path, in which the exit trajectories are substantially parallel to one another.

For example, in some implementations, the deflecting instrument includes a linear array of dipole magnets. Each dipole magnet can be separated from an adjacent dipole magnet by a spacing in which the linear array of magnets is parallel to an incident beam direction. The number of positions on the linear path to which the beam can be deflected can be greater than the number of magnets.

In some cases, the apparatus includes a power source and a plurality of amplifiers coupled to the power source in which activation of one or more of the amplifiers allows the deflecting instrument to be energized by the power source. Each amplifier can include a switch mode amplifier or a power amplifier. The number of amplifiers can be less than the number of dipole magnets.

In some implementations, the apparatus can include an energy storage device coupled to the power source. The energy storage device can be a capacitive storage bank.

In certain cases, the apparatus includes a beam conditioning element selected from the group including quadrupole magnets, steerer magnets, sextupoles, solenoids and combinations thereof.

In some cases, the apparatus includes a high voltage power source.

In some examples, the deflecting instrument includes one or more modular units.

In another aspect, a system for delivering a beam of charged particles includes a source for producing the beam of charged particles, a deflecting instrument operable to deflect the beam along a plurality of exit trajectories to any position on a linear path, in which the exit trajectories are substantially parallel to each other and a controller to activate the deflecting instrument.

For example, in some implementations, the deflecting instrument includes a linear array of dipole magnets. The number of positions on the linear path to which the beam can be deflected can be greater than the number of magnets.

In some cases, the system includes memory to store settings for the dipole magnets. The processor is operable to interpolate settings for the dipole magnets.

In some implementations, the system includes a power source and a plurality of amplifiers coupled to the power source in which activation of one or more of the amplifiers allows the deflecting instrument to be energized by the power source. Each amplifier can include a switch mode amplifier. Each amplifier can include a power amplifier. The number of amplifiers can be less than the number of dipole magnets.

In some cases, the system can include an energy storage device coupled to the power source. The energy storage device can be a capacitive storage bank.

In some implementations, the system can include a beam conditioning element selected from the group including quadrupole magnets, steerer magnets, sextupoles, solenoids and combinations thereof.

In certain instances, the system includes a high voltage power source.

In some implementations, the deflecting instrument includes one or more modular units.

Various features and advantages will be apparent from the description, drawings and the claims.

### DESCRIPTION OF DRAWINGS

FIG. 1 illustrates an example of a system for delivering charged particles.

FIG. 2 illustrates an example of a system for delivering charged particles.

FIG. 3 illustrates an example of a system for delivering charged particles.

FIG. 4 illustrates an application of a charged particle delivery system.

FIGS. 5A-5B illustrate examples of a system for delivering charged particles.

FIG. 6A shows an example array of magnets.

FIG. 6B illustrates example settings for magnets in an array.

FIG. 7 illustrates examples of magnetic field intensities plotted versus time.

FIG. 8 illustrates an example of a switching circuit a charged particle delivery system.

FIG. 9 illustrates an example of a switching circuit for a charged particle delivery system.

FIG. 10 shows an example of a circuit for a charged particle delivery system.

FIG. 11 illustrates an example of a system for delivering charged particles.

FIGS. 12A-12C show example applications of a charged particle delivery system.

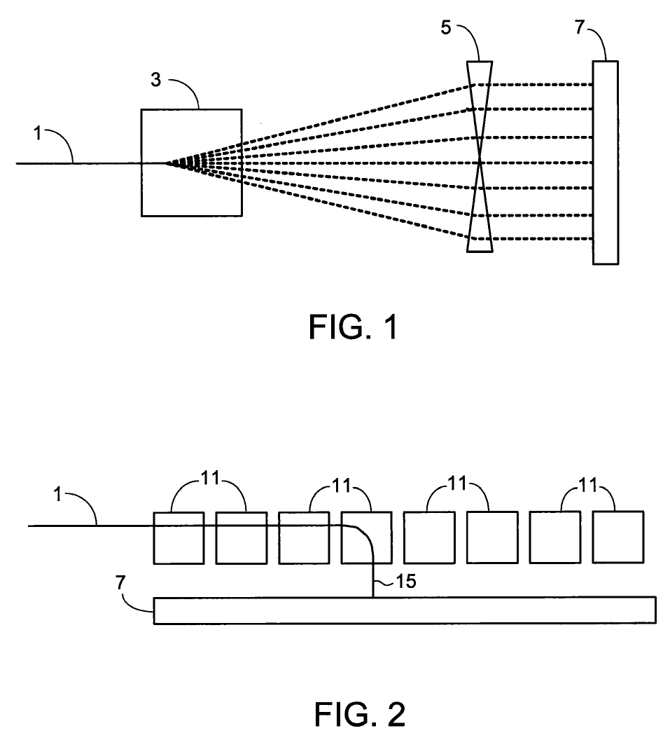

### DETAILED DESCRIPTION

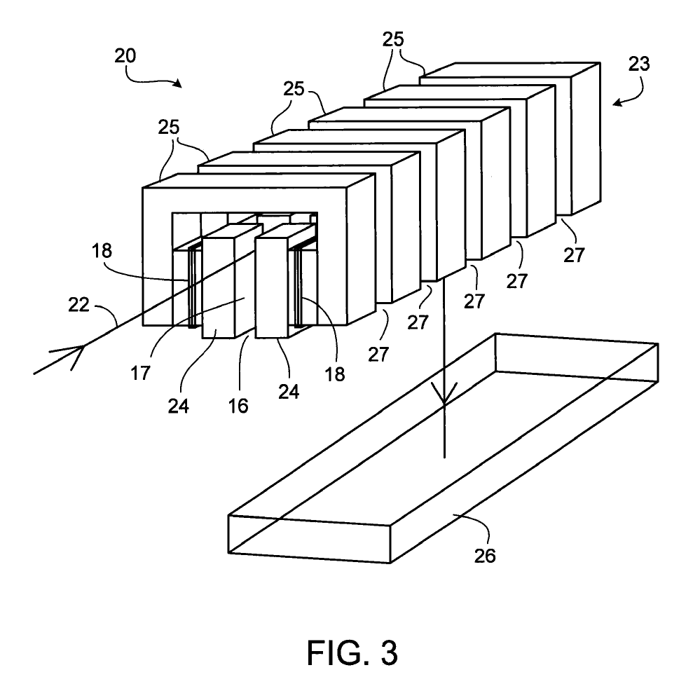

In contrast to a linear array in which only a single magnet is energized, the present system utilizes multiple energized dipole magnets to deflect a charged particle beam by multiple angles along the length of the array. An example system 20 for delivering charged particle beams is shown in FIG. 3. The system 20 includes a linear array 23 of dipole magnets 24 with poles 17 and return yokes 25 through which an incident beam 22 of charged particles enters. The region between the poles 17 of each magnet 24, where the incident beam passes through, is known as the pole gap 16. As the beam travels through the array 23, two or more of the magnets 24 are energized by passage of current through coils 18 which generates a nominally uniform magnetic field that fills the pole gap 16 volume. The magnetic field is a vector field with a uniform vector direction across the pole gap 16. Thus, the direction of the magnetic field is orthogonal to the beam direction and to the direction of force on the beam, as required by the Lorentz equation. The magnetic field also extends across the area of the poles 17 of each energized magnet.

Depending on the power applied to each energized magnet 24, the combined magnetic field can deflect the beam 22 by various angles onto a target 26. Moreover, by energizing multiple magnets 24, a user can select an exit beam trajectory that is substantially orthogonal to the entrance trajectory and which is not constrained to a single exit position. Instead, the beam can exit the array 23 at any arbitrary position along a straight linear path, including positions that coincide with a spacing 27 between adjacent magnets 24. Thus, energizing multiple magnets 24 provides an additional degree of freedom for positioning the exit beam trajectory.

The magnet poles 17 and return yokes 25 can be composed of materials including, but not limited to, ferrite compounds, silicon steel or low carbon steel. The magnets 24 can be formed to have an appropriate size for the particular application.

Typically, the path of the particle beam is under vacuum conditions in order to obtain acceptable beam transmission. The beam can be placed under vacuum conditions according to multiple different system arrangements. For example, a thin-walled vacuum vessel through which the beam travels may be placed between the poles of each magnet 24 of the linear array 23. To minimize the generation of eddy current loops due to the presence of the vacuum vessel, the vessel walls can be formed of a poor conductivity material such as stainless steel. Alternatively, the vacuum vessel can be formed from a non-conducting material such as ceramic, and include a very thin layer of conductive material on its inner walls to allow charge to dissipate. In another example, the magnet poles can be arranged in the walls of the vacuum vessel such that the pole faces are in the vacuum. In that case, a vacuum seal may be necessary around each pole. In some implementations, the complete magnet array can be placed inside a large vacuum vessel. Other vacuum arrangements can be used as well.

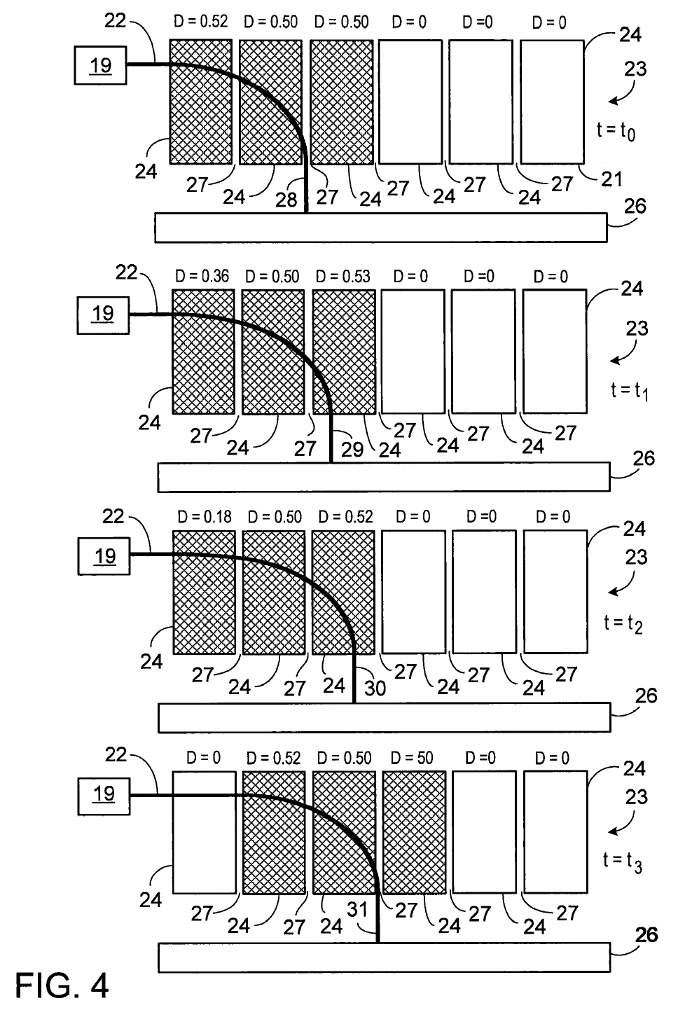

An example application of the system under operation is shown in FIG. 4. In that example, a charged particle beam 22 is delivered from a source 19 at times t=t₀, t₁, t₂, and t₃ to discrete positions along an extended target 26 in exit trajectories 28, 29, 30 and 31. The beam 22 is stepped between the exit trajectories as quickly as possible by consecutively energizing different sets of two or more magnets 24. The beam dwell time at each exit trajectory is chosen according to the needs of the particular application. Energized magnets are depicted using cross-hatching. The normalized value D of the applied magnetic field is listed above each magnet 24 in FIG. 4. Magnets that are not activated have a magnetic field equal to zero. When an energized magnet is no longer necessary for beam deflection, the magnet is de-energized. In some cases, the magnetic field in the pole gap 16 does not go immediately to zero when the coil current is reduced to zero because of residual magnetization of the yoke and poles. In those situations, the magnet 24 can be actively driven to a zero magnetic field in the pole gap 16 by applying a nulling current through the coil 18.

The power consumed by each energized magnet at each exit trajectory is not necessarily the same. Each outgoing beam is deflected 90° from its corresponding input trajectory towards the target 26. In some implementations, for example, the distance between the impact positions of the beams on the target can be several centimeters or less. At the limit, the motion of the beam spot may be continuous.

If only two magnets 24 are energized, there is a single composite field solution at every position along the exit face 21 of the linear array 23 where the beam 22 can be deflected by 90°. If three or more magnets are energized, there are multiple field solutions for deflecting the beam 22 by 90° at each position along the exit face 21 of the array 23. Preferably, the solution which consumes the least amount of power or which provides the easiest transition between settings is the one used to direct the beam onto the target 26. In addition, energizing three or more magnets allows the user to switch between energized magnets faster because the change in supply current with time, or slew rate, is reduced.

The charged particles can, in some cases, be deflected along exit beam trajectories that coincide with the spacing 27 between magnets 24, while remaining substantially orthogonal to the input beam trajectory. Such deflection can be achieved by utilizing the fringe magnetic fields which extend into the spacing 27. In addition, the fringe magnetic fields can be compensated or modified depending on the number of adjacent energized magnets 24.

During beam scanning, magnets 24 that are not actively deflecting the beam 22 can be set to a desired field strength in preparation for future deflection of the beam 22. Setting the magnetic field involves increasing or decreasing the magnetic field energy by changing the current supplied to the magnet 24. Since the dipole magnet 24 can be modeled as an inductor and resistor in series, the voltage V needed to drive the magnet 24 is given by the equation V=L*(dI/dt)+IR where L is the coil inductance, I is the current, and R is the resistance. Accordingly, fast current switching of the magnet 24 requires high driving voltages for typical magnet inductance values. High voltages typically correspond to voltage levels of approximately 1000 Volts or more, depending on the available technology. However, the power amplifiers capable of providing such high voltages can be costly. In order to reduce the voltage requirement, the current supplied to the magnet 24 can be ramped to the desired setting over a long period of time rather than quickly switched. As a result, less expensive power amplifiers can be used.

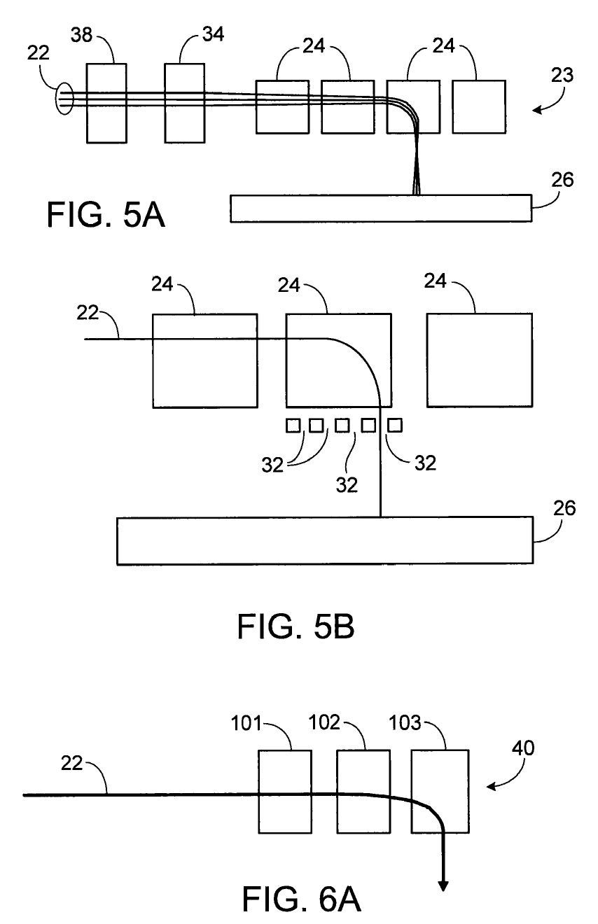

In some cases, beam conditioning elements can be included in the system. For example, beam focus elements, such as quadrupole magnets 34, can be located upstream to control the divergence of the beam 22 such that it comes to a focus at a given position relative to the target 26 after the deflection. Each quadrupole focuses along a single axis. Accordingly, additional quadrupoles can be included in the system to control the beam divergence along multiple axial directions. An example of a quadrupole magnet 34 focusing a parallel beam 22 is shown in FIG. 5A. In addition to changing the focus property of a beam, the quadrupole magnets 34 also can maintain the focus of a beam incident on the magnet array 23. Moreover, the quadrupole settings can be stepped in synchronization with the stepping of the exit beam trajectory such that a constant beam size is maintained as the target is scanned. In some cases, solenoids can be used in place of quadrupole magnets 34. In addition or alternatively, sextupole magnets can be used to provide a second order correction to the beam shape.

Fine adjustments to the exit trajectories can be made using one or more steerer magnets 38 also positioned upstream. Thus, adjustments to the input beam 22 using the steerer magnet 38 can, in some applications, cause corresponding changes in the beam output trajectory. An example of a steerer magnet 38 is shown in FIG. 5A. Preferably, a steerer magnet 38 is used to correct misalignment of the incoming beam 22 relative to the dipole array 23 and the axis of the quadrupoles 34. Generally, steerer magnets are small dipole magnets that exhibit a relatively low magnetic field.

Additionally, apertures 32, through which the beams must pass, can be used to ensure that any beams exiting the array 23 propagate in a direction perpendicular to the target 26. For example, in some cases, a beam passing through the magnet array 23 is dispersed transverse to the direction of propagation. Typically, the amount of dispersion is proportional to the amount p/q where p is particle momentum and q is the particle charge. Given that only particles with a narrow range of momenta, and thus energy, can pass through an aperture 32, the dipole magnet 24 and aperture 32 combine to effectively act as a filter which restricts passage to those particles propagating in a direction substantially perpendicular to the target 26. For applications in which there are multiple exit positions per magnet, multiple apertures 32 should be provided as shown in FIG. 5B.

High energy beams or electron beams are particularly suited for use in the system 20 as they generally can be formed with low emittance. Accordingly, the beams may be transported along the dipole magnet array 23 without significant spreading. This can be important in applications that favor similar angular characteristics for each exit beam. Furthermore, given that electron beams are easy to bend in magnetic fields, relative to other charged particle beams, the magnets 24 can be designed for use at higher energies.

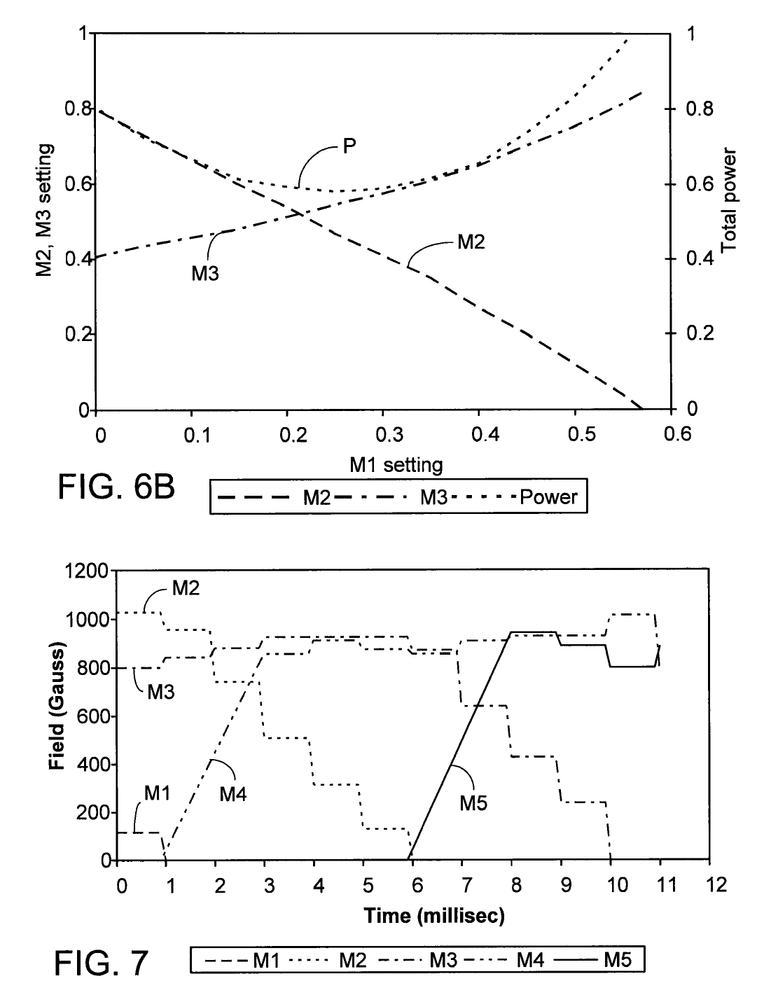

FIG. 6A shows an example array 40 that includes first, second and third magnets 101, 102, 103, which will generally be part of a larger array. An input beam 22 is deflected to a position half-way along the third magnet 103 by energizing the first, second and third magnets 101, 102, 103 in some combination. FIG. 6B shows the normalized values of the magnetic fields, i.e., “settings,” that are applied to each of the second and third magnets 102, 103, as a function of the setting chosen for the first magnet 101, to achieve the deflection shown in the example of FIG. 6A. The setting for the second magnet 102 is identified by the dashed line labeled “M2,” whereas the setting for the third magnet 103 is identified by the dashed-dotted line labeled “M3.” An estimate of the total magnet power necessary to maintain the beam position, as a function of the first magnet setting, is shown as a dotted line labeled “P” in FIG. 6B. Thus, the settings of magnets 102, 103, which provide the specified beam position and angle shown in FIG. 6A, are recorded for every magnetic field value of the first magnet 101 over a specified range.

In the case where the magnet poles and yokes are clear of saturation, the total magnet power is linearly related to the sum of the squares of the pole gap field values. Thus, magnet power P=m(I²), where m is the coil resistance when no eddy currents are present and I is the current. The current I is linearly proportional to the magnetic field B according to I=kB, where k is a proportionality constant. As shown in the graph of FIG. 6B, there can be an optimum setting for the three magnets which minimizes the total power. Alternatively, a setting can be chosen that minimizes the maximum power needed in any one magnet. By minimizing the maximum power, smaller magnet amplifiers can be chosen that are capable of providing that maximum power to the particular magnet. Accordingly, the system cost can be reduced.

FIG. 7 illustrates simulation examples of magnetic field intensities plotted versus time for each magnet 24 in a linear array of 5 dipole magnets (M1, M2, M3, M4 and M5) where the position of an exit beam trajectory is incremented in 5 cm steps every millisecond. The magnets M1-M5 are The length of each magnet exit face 48 used in the example is about 20 cm whereas the size or distance of each spacing 27 which separates the magnets 24 is approximately 3 cm. In the example, either two or three magnets are simultaneously energized for each exit beam trajectory.

The energized magnets 24 store energy in their fields. Given that the total field energy applied to a magnet array does not change greatly with exit beam position, a power supply switching circuit can be constructed that recovers energy from and delivers energy to a capacitive storage bank as the magnets 24 are respectively energized and de-energized. In this way, the energy necessary to generate the magnetic fields can be recycled and the energy discarded by de-energizing magnets can be reduced. Accordingly, the efficiency of the system can be improved. Without the use of the power supply switching circuit and a capacitive storage bank, field energy would be lost as heat generated in resistors.

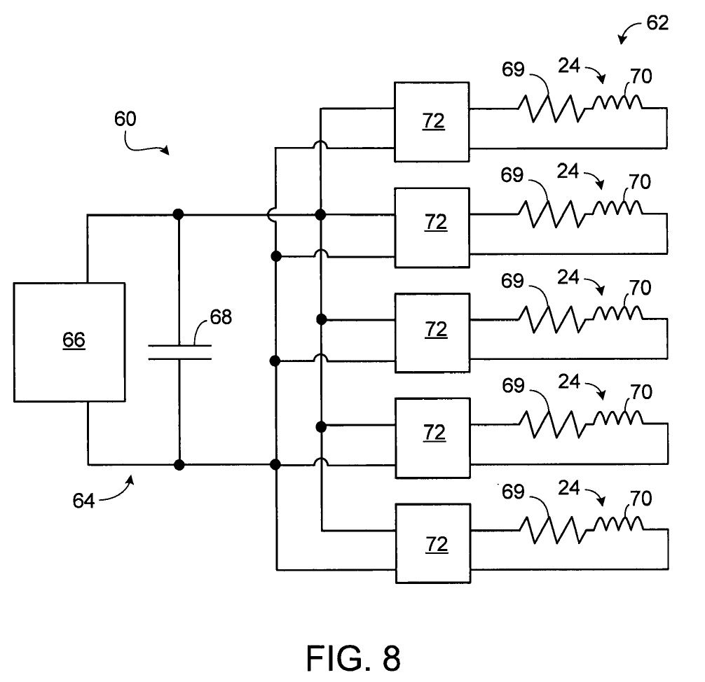

For example, FIG. 8 illustrates a switching circuit 60 in which an array 62 of magnets 24 are coupled to a capacitive storage bank 64. The storage bank 64 includes a DC power supply 66 electrically connected in parallel with an energy storage capacitor 68. Each dipole magnet 24 is represented as a series resistance 69 and inductance 70 and is connected to an independent power amplifier 72. The amplifiers 72 can be switch-mode amplifiers that switch at frequencies of approximately ten to several hundred kilo-Hertz. The flow of current between the magnets 24 and the capacitive storage bank 64 is controlled by the pulse width modulation of the switch on/off duty cycle.

As an example, when a magnet 24 is no longer in use after deflecting a beam to a given position, an amplifier associated with that magnet operates to recover energy from the magnet 24 and store the energy in a storage capacitor 68 until it is needed again. The operation of the amplifier can be in response to a signal received from a control system, which indicates that there is zero demand for current. By recycling the magnetic energy between magnet coils, a high-efficiency system is possible.

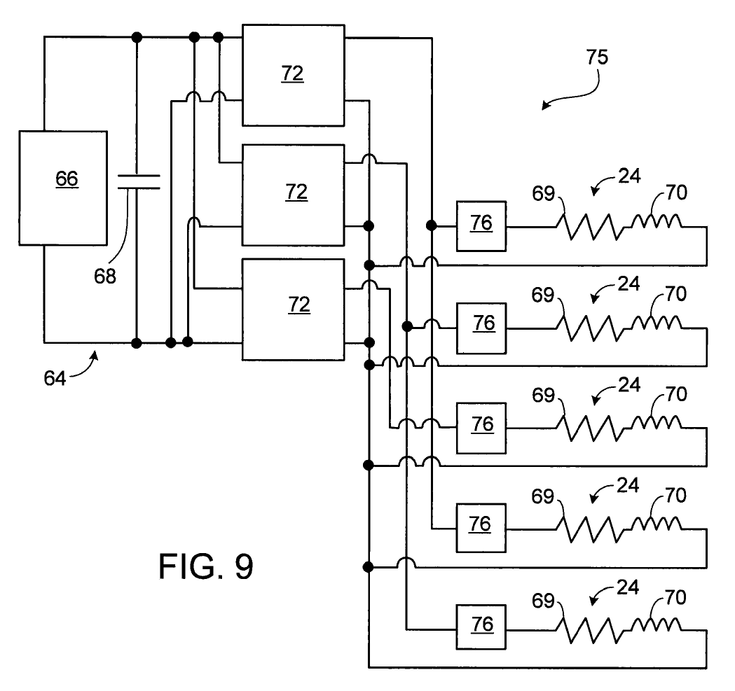

Additionally, in some applications, the total number of independent power amplifiers 72 can be reduced by coupling each amplifier 72 to multiple magnets 24 using an arrangement of high power fast current switches 76. For example, as illustrated in the switching circuit 75 of FIG. 9, each power amplifier 72 is connected to a separate group of fast current switches 76. In turn, each switch 76 within a particular group is connected to an individual dipole magnet 24. In order to deliver current to a particular magnet 24, a single switch 76 in a group should be activated at a time. Once the current in the magnet 24 is reduced to zero, the active switch is opened and a second switch is closed, allowing current to flow to a second magnet. The process proceeds in parallel for each amplifier in the system. Accordingly, energy can be delivered to or removed from multiple magnets 24 simultaneously without requiring the number of amplifier stages to exceed the maximum number of magnets energized at any one time. As a result, the system cost may be reduced. Examples of high power switches 76 include, but are not limited to, high power field effect transistors (FETs) and insulated gate bipolar transistors (IGBTs).

In some implementations, a cost-efficient system can be employed that does not utilize expensive current-programmed amplifiers. As discussed above, fast current switching of the magnet 24 requires high driving voltages. Accordingly, a fixed high-voltage signal can be applied to the magnet coil so as to rapidly ramp to the desired magnetic field strength at a rate limited only by the magnet inductance and the voltage level. A suitable switching sequence could cause a wave of excitation to pass along the magnet array to scan the beam at a particular rate. If the beam is to be held at a particular position, then a feedback control system can be used to maintain constant current in each energized magnet during the hold. This feedback system could utilize the same switches, but now operating in a pulse width modulated manner.

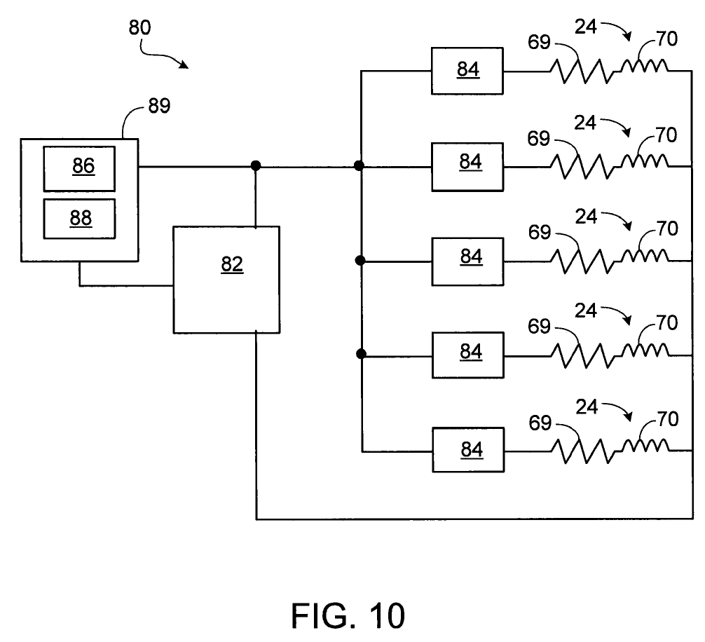

FIG. 10 shows an example system 80 in which fixed high-voltage signals are supplied from a high-voltage source 82 and applied to each magnet 24. The system 80 includes high power field effect transistor (FET) switches 84 implemented at each dipole magnet 24. The high-voltage signals then are fed back to a processor 86, which makes adjustments to the output voltages provided by the source 82. Typical voltage levels supplied by the source 82 may vary, for example, between 100 and several thousand volts. In some implementations, voltage sensing and feedback elements can be co-located within the switches 84 in which the feedback elements are responsible for activating of the switches 84 and changing the switch operation to alternative modes such as, for example, pulse width modulation.

The magnet coil current settings needed to move the exit beam trajectory to a finite number of arbitrary positions along a target may be stored in an electronic memory 88. By storing a large number of such settings in the memory 88, it is possible to obtain smooth, continuous and stable scans across a target. Furthermore, if the settings for only a few scan positions are available, the processor 86 can derive any intermediate settings by means of mathematical fitting functions, such as polynomials or splines. The ability to switch between settings or scan the exit beam position at high speed may be limited by the inductance of the magnets and the voltage compliance and bandwidth of the power amplifiers, if used.

The processor 86 and memory 88 can be provided in a user terminal 89 that also includes a user interface displayed on a display. The terminal 89 allows a user operating the charged particle delivery system to observe changes in or make adjustments to system parameters such as beam position and angle, magnet field strength, and current and voltage levels. The user terminal 89 also may include a number of additional external or internal devices, such as, without limitation, a mouse, a CD-ROM, digital signals processors, field programmable gate arrays and a keyboard.

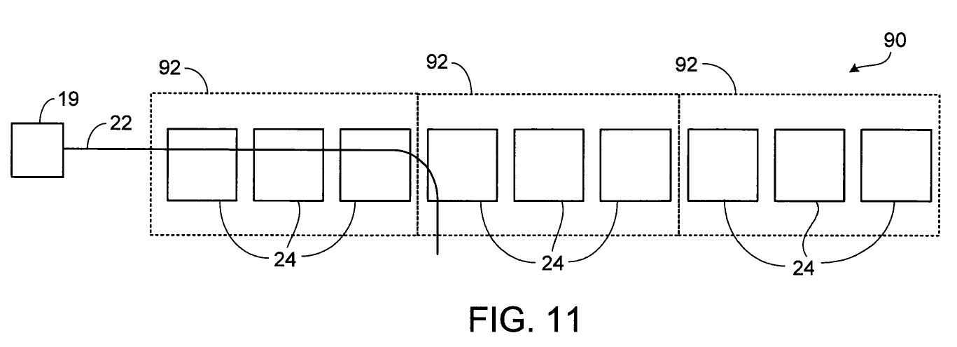

As shown in FIG. 11, a system for delivering charged particle beams can be modular in design. For example, an array 90 of magnets 24 is constructed in subsections 92, in which each sub-section 92 includes three dipoles magnets 24 in addition to any associated vacuum chamber sections and services. The number of dipole magnets 24 in each sub-section 92 is variable such that a complete array of any length may be built up by combining sub-sections 92.

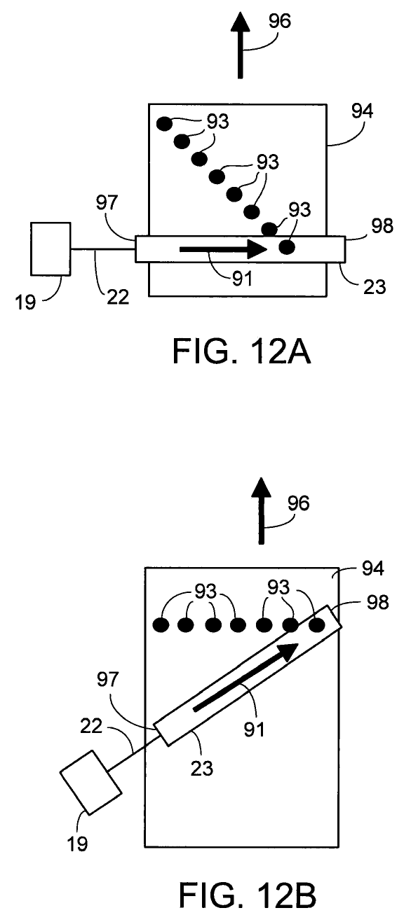

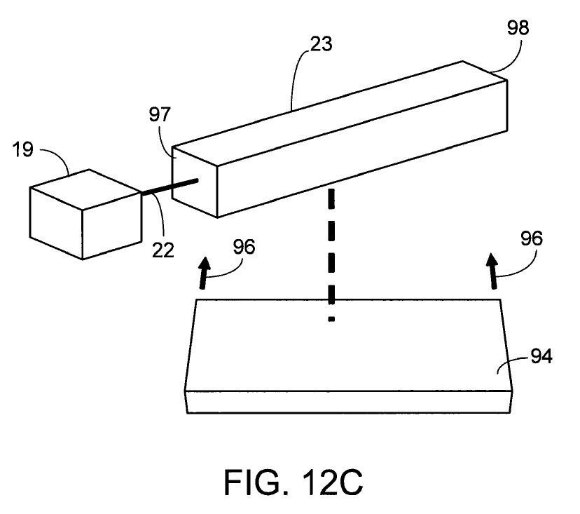

FIG. 12A illustrates a top view of an example application in which the linear magnet array 23 is used to irradiate an object 94 translated beneath the array 23 in a direction indicated by the arrow 96. The array 23 is operated using a flyback procedure in which the position of the exit beam trajectory is stepped in a direction 91 from a first end 97 of the array 23 to a second end 98 of the array 23. Once the beam position has reached the second end 98 of the array 23, the beam returns or “flies back” to the original position at the first end 97 of the array 23 and continues as before. During the beam “fly back,” the beam can be blocked or gated off so that unwanted irradiation of the object 94 is avoided. Ordinarily, the direction in which the beam position is stepped is perpendicular to the direction of motion of the scanned object 94 as shown in FIG. 12A. However, in some cases, this results in positions 93 on the object 94 being irradiated at an angle with respect to the object side as the object 94 is translated. In order to compensate for this effect, the magnet array 23 can be angled, as shown in FIG. 12B, such that the irradiation pattern is parallel with the object side. Scanning a target in this manner is important in applications such as radiography in which it is preferable to build up a uniform volumetric map of the target. An isometric view of the charged particle system is shown in FIG. 12C.

In some cases, a portion of the magnetic flux of a first magnet couples to one or more adjacent magnets and produces a magnetic field in the adjacent pole gaps 16. The amount of coupling depends on the relative geometry of the pole gaps 16 as well as the spacing 27 between magnets 24. This effect can complicate the calculation of where the beam will go upon deflection. However, a computer-control system can compensate for the adverse magnetic field coupling. For example, the positions and/or the angles of deflected beams on a target can be measured at various target positions for nominal magnet excitation patterns. The measurements then are recorded by the computer system and the excitation pattern is automatically tuned or adjusted by the computer system to achieve the desired positions and angles, thus compensating for the adverse effects of magnetic field coupling between magnets.

Various aspects of the system may be implemented in hardware, software or a combination of hardware and software. Circuitry, including dedicated or general purpose machines, such as computer systems and processors, may be adapted to execute machine-readable instructions to implement the techniques described above. Computer-executable instructions for implementing the techniques can be stored, for example, as encoded information on a computer-readable medium such as a magnetic floppy disk, magnetic tape, or compact disc read only memory (CD-ROM).

A number of embodiments of the invention have been described. Nevertheless, various modifications may be made without departing from the spirit and scope of the invention. Other implementations are within the scope of the claims.

What is claimed is:

1. A method for delivering a beam of charged particles comprising:
providing the beam along a first trajectory to a linear array of magnets; and
energizing two or more of the magnets in the linear array to deflect the beam to a second trajectory,
wherein the second trajectory is substantially orthogonal to the first trajectory, and
wherein the beam is deflectable to any position along a straight linear path.

2. The method according to claim 1 further comprising:
subsequently energizing two or more of the magnets in the linear array to deflect the beam to a third trajectory,
wherein the third trajectory is substantially parallel to the second trajectory, and
wherein charged particles from the second and third trajectory are aligned at any position along the straight linear path.

3. The method according to claim 1 wherein the first trajectory is substantially parallel to the straight linear path.

4. The method according to claim 1 further comprising de-energizing the two or more magnets,
wherein energizing the two or more magnets comprises retrieving energy from an energy storage device and
wherein de-energizing the two or more magnets comprises delivering energy to the energy storage device.

5. The method according to claim 1 wherein the linear array of magnets comprises one or more spacings, wherein each spacing is between a set of adjacent magnets, wherein each spacing extends in a direction parallel to the first trajectory and wherein the second trajectory coincides with one of the spacings.

6. A method of delivering a charged particle beam comprising:
providing the beam along a first trajectory to a linear array of deflecting elements; and
deflecting the beam along a plurality of exit trajectories to any position on a linear path, wherein each exit trajectory is substantially parallel to one another.

7. The method of claim 6 wherein each exit trajectory is substantially orthogonal to the linear path and to the first trajectory and wherein the first trajectory is substantially parallel to the linear path.

8. The method of claim 6 wherein deflecting the beam along a plurality of exit trajectories comprises successively activating a plurality of the deflecting elements in the linear array,
wherein activating the plurality of deflecting elements comprises retrieving energy from an energy storage device.

9. The method according to claim 6 further comprising de-activating a plurality of deflecting elements, wherein de-activating the plurality of deflecting elements comprises delivering energy to an energy storage device.

10. The method of claim 6 wherein the linear path is arranged at an oblique angle with respect to a direction of motion of a target.

11. The method of claim 10 further comprising sequentially activating the deflecting elements such that charged particles within the exit trajectories impinge on the target along a line substantially orthogonal to the target direction of motion.

12. An apparatus for delivering a beam of charged particles comprising a linear array of dipole magnets operable to deflect the beam along a plurality of exit trajectories to any position on a linear path,
wherein the exit trajectories are substantially parallel to one another, and
wherein the number of positions on the linear path to which the beam can be deflected is greater than the number of magnets.

13. The apparatus of claim 12 further comprising:
a power source; and
a plurality of amplifiers coupled to the power source wherein activation of one or more of the amplifiers allows the linear array of dipole magnets to be energized by the power source.

14. The apparatus of claim 13 wherein each amplifier comprises a switch mode amplifier and wherein the number of amplifiers is less than the number of dipole magnets

15. The apparatus of claim 13 wherein each amplifier comprises a power amplifier.

16. The apparatus of claim 13 further comprising an energy storage device coupled to the power source.

17. The apparatus of claim 12 further comprising a beam conditioning element selected from the group including quadrupole magnets, steerer magnets, sextupole magnets, solenoids and combinations thereof.

18. The apparatus of claim 12 wherein the linear array of dipole magnets comprises one or more modular units.

19. A system for delivering a beam of charged particles comprising:
a source for producing the beam of charged particles;
a linear array of dipole magnets operable to deflect the beam along a plurality of exit trajectories to any position on a linear path; and
a controller to activate the linear array of dipole magnets,
wherein the exit trajectories are substantially parallel to each other, and
wherein the number of positions on the linear path to which the beam can be deflected is greater than the number of magnets.

20. The system of claim 19 further comprising:
a processor operable to interpolate settings for the dipole magnets and
a memory to store the settings for the dipole magnets.

21. The system of claim 19 further comprising:
a power source; and
a plurality of amplifiers coupled to the power source wherein activation of one or more of the amplifiers allows the linear array of dipole magnets to be energized by the power source.

22. The system of claim 21 wherein each amplifier comprises a switch mode amplifier or a power amplifier, wherein the number of switch mode amplifiers is less than the number of dipole magnets.

23. The system of claim 21 further comprising an energy storage device coupled to the power source.

24. The system of claim 19 further comprising a beam conditioning element selected from the group including quadrupole magnets, steerer magnets, sextupole magnets, solenoids and combinations thereof.

25. The system of claim 19 wherein the linear array of dipole magnets comprises one or more modular units.
